(19) United States
(12) Patent Application Publication
(10) Pub. No.: US 2011/0203127 A1
(43) Pub. Date: Aug. 25, 2011

(54) Metal clip the pencil caddie

(76) Inventor: Lance David Mayfield, Redding, CA (US)

(21) Appl. No.: 12/660,214

(22) Filed: Feb. 22, 2010

(51) Int. Cl. G01B 3/10

(52) U.S. Cl. 33/768

(57) ABSTRACT

A metal clip molded into or used in conjunction with a standard recoil tape measure. The purpose of the clip is to hold a standard carpenters pencil which has six sides.

This clip has a solid back which attaches to a standard recoil tape measure. The front of the clip has two finger like tabs which grip the pencil and may be adjusted with an individuals fingers to accommodate the different thicknesses of a carpenters pencil and to allow for easy removal of the pencil from the clip.

### BACKGROUND OF THE INVENTION

This invention is a one piece metal clip which is shaped to hold firmly a carpenters pencil. A tradesman or handyman normally holds a carpenters pencil behind their ear, in their front or back pocket or in the band of their hat. This pencil clip allows a tradesman the consistency of having the pencil at their side throughout the project. This saves time and the frustration of the lead of the pencil always breaking, and always looking for their pencil.

This one piece metal clip is attached to a standard recoil tape measure. The optimum use would be the clip designed and manufactured into the tape measure. Additional methods of attachment to the tape measure would be a super bonding glue, or a set screw into the tape measure.

This clip has a solid back which attaches to the tape measure. The front of the clip has two finger like tabs which grip the pencil and may be adjusted with an individuals fingers to accommodate the different thicknesses of manufactured carpenters pencils. Carpenters pencils are normally manufactured from wood and also tend to swell when wet, making it necessary to adjust the two tabs of the clip.

As the pencil is sharpened repeatedly it shortens in length. The clip has a void in the front between the two tabs. The void is necessary for the easy removal of the shorter pencil.

The clip has the features in accompanied drawings.

### BRIEF DESCRIPTION OF THE DRAWINGS

The following illustrations demonstrate the simplicity and novelty of the clip.

FIG. 1 is the perspective of a standard recoil tape measure with the clip attached to its side. 15 is the tape measure. 16 is the metal clip. 17 exhibits the two identical finger like tabs on the front of the clip.

FIG. 2 shows the face of the tape measure. 18 shows the void or hollow area between the two tabs allowing the users one finger to pull up on the carpenters pencil for easy removal.

FIG. 3 shows the side view of the tape measure with the metal carpenters pencil holder clip. 19 is the precise design of the clip to accommodate a carpenters pencil.

FIG. 4 shows the top view of a tape measure. 20 shows a carpenters pencil in the clip

FIGS. 5,6 and 7 show the clip and its precise dimensions to accommodate a carpenters pencil.

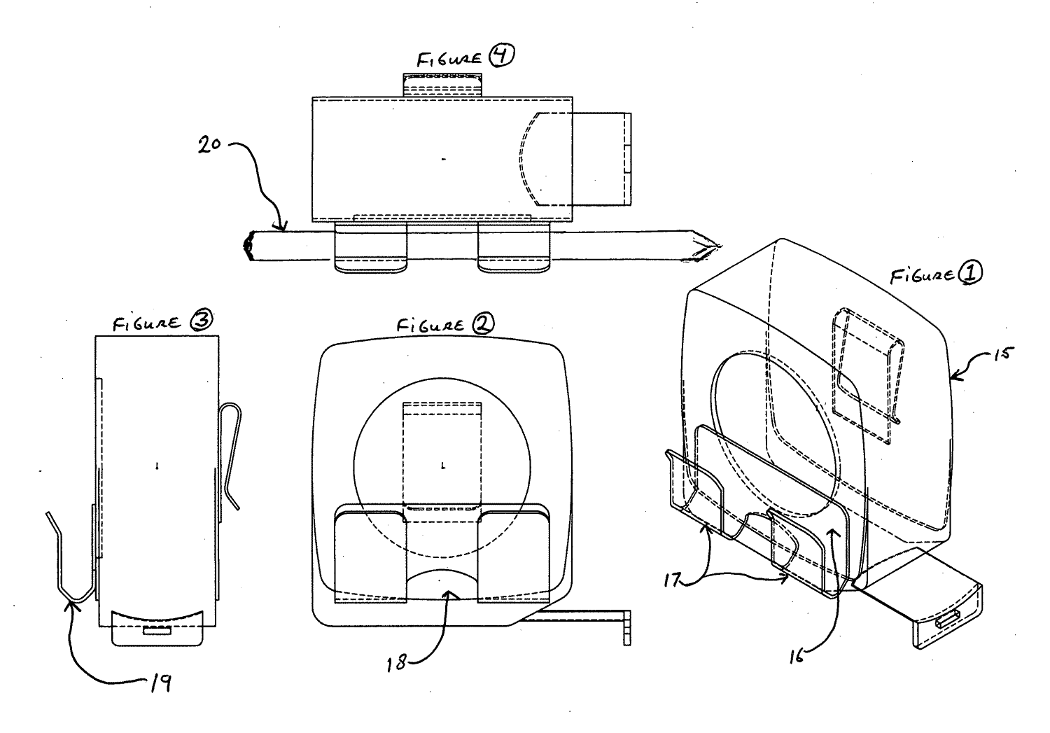

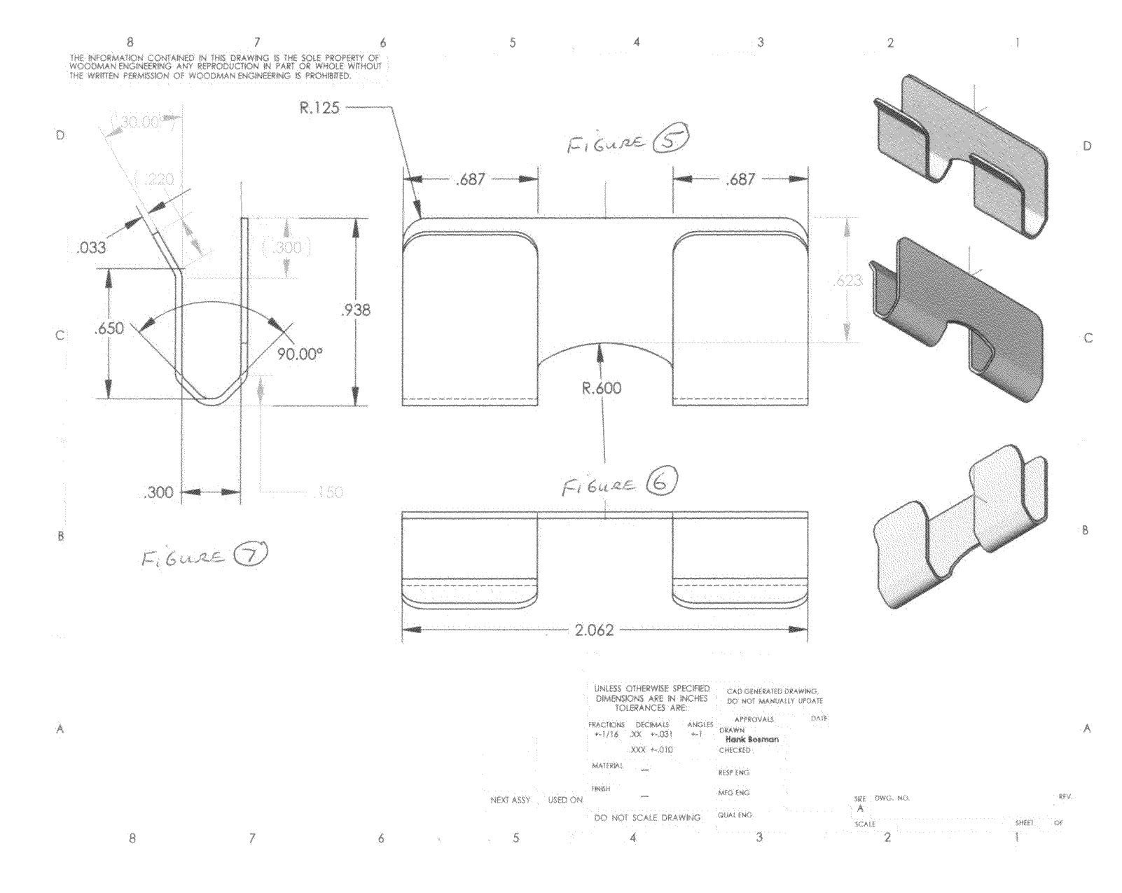

Previous inventions accommodate carpenters pencils also. The purpose of this older art is too perform a function like scribing a circle. The intention of the Pencil Caddie carpenter pencil clip is a rigid holder for the easy placement and removal of a carpenters pencil. The tradesman is focused on their work and does not need the inconvenience of looking for the pencil or having the lead of the pencil break because the pencil is placed in a pocket or such. The claims of this invention are on the following page.

### SUMMARY OF THE INVENTION DISCLOSURE

I am a ceramic tile contractor by trade. I have personally used the metal clip which I have named the Pencil Caddie. I have used the Pencil Caddie for about two years on the job. This clip has saved me considerable time and frustration.

I was working on a commercial tile project when I had to climb up a ladder to mark a piece of tile with a pencil. I always kept a carpenters pencil behind my ear. I looked up to hold the piece of tile in place to mark it with the pencil and it fell from behind my ear to the ground and broke the lead point. I thought there must be a convenient way to hold a carpenters pencil.

When the pencil is new it is easier to hold it in your front or back pocket. When you bend over the lead point tends to snap or break. When the pencil gets smaller it is easier to hold it behind your ear. When you move your head up or down it usually slides to the ground and breaks the lead point.

I built a prototype out of stainless steel. I originally designed it to have a solid back and a solid front similar to a metal clip which is already connected to a standard recoil tape measure to clip onto ones pocket.

I designed the original Pencil Caddie clip with five sides to accommodate the shape of a carpenters pencil.

I found if I separated the front into two separate tabs and left a hollow area I could use one finger to easily remove the carpenters pencil from the Pencil Caddie clip. The two tabs also allow the user to bend the tabs to accommodate the different thicknesses of carpenters pencils. I use a lot of water in the tile trade and the wood pencil gets wet often and tends to swell. The two finger tabs on the face of the Pencil Caddie are easily adjustable for this occurrence.

I have used a high bonding glue to attach the Pencil Caddie clip to several commercially manufactured recoil tape measures. This works well accept under extreme cold environments. The glue or adhesive tape tends to falter and the clip has separated from the tape measure.

Manufacturers of commercially sold tape measures use a guide and a screw to hold their metal belt or pocket clips in place. This application would work too, but I feel the best application would be to design and develop the Pencil Caddie clip into the mold of an existing commercially sold recoil tape measure or a newly designed tape measure.

1. A one piece metal clip used in conjunction with a recoil tape measure. The metal clip is flat on one side and is bent and angled on the under side and front to accommodate holding a carpenters pencil. There are five total sides to the metal clip.

2. The invention may be attached to a standard recoil tape measure by means of initial design whereas the clip may be molded into the recoil tape measure. The clip may also be attached to a tape measure using a super bonding glue or a single set screw and guides similar to the pocket clip already manufactured for recoil tape measures.

3. The face of the invented metal clip has two similar finger like tabs. These tabs are bendable to accommodate different thicknesses of carpenters pencils. The clip is built with a precise thickness stainless steel of 0.040.

4. The void between the two tabs on the clip allows the user to easily push the pencil into place and also easily remove the pencil with one finger.
